(19) United States
(12) Patent Application Publication
(10) Pub. No.: US 2025/0065945 A1
(43) Pub. Date: Feb. 27, 2025

(54) STEERING EFFORT HYSTERESIS SHAPING FOR STEER-BY-WIRE AND CLOSED-LOOP ELECTRIC POWER STEERING

(71) Applicant: Steering Solutions IP Holding Corporation, Saginaw, MI (US)

(72) Inventors: Jeffrey R. Meyer, Munger, MI (US); Joel E. Birsching, Vassar, MI (US)

(21) Appl. No.: 18/812,073

(22) Filed: Aug. 22, 2024

Related U.S. Application Data
(60) Provisional application No. 63/534,392, filed on Aug. 24, 2023.

(51) Int. Cl. B62D 6/00

(52) U.S. Cl. CPC B62D 6/00

(57) ABSTRACT

A method for performing hysteresis shaping in a steer-by-wire (SbW) steering system of a vehicle includes determining a desired hysteresis associated with rotating a handwheel of the vehicle, determining, based on the desired hysteresis, whether to perform hysteresis subtraction or perform hysteresis addition, in response to a determination to perform hysteresis subtraction, calculating a hysteresis subtraction value, modifying an estimated rack load based on the hysteresis subtraction value, and generating a reference torque based on the estimated rack load as modified based on the hysteresis subtraction value, in response to a determination to perform hysteresis addition, calculating a hysteresis addition value and generating the reference torque based on hysteresis addition value, and controlling the handwheel based on the reference torque.

### CROSS-REFERENCE TO RELATED APPLICATIONS

This application claims the benefit of U.S. Provisional Application No. 63/534,392, filed on Aug. 24, 2023. The entire disclosure of the applications referenced above is incorporated herein by reference.

### TECHNICAL FIELD

This disclosure relates to control of components in electronic power steering (EPS) and Steer-by-Wire (SbW) steering systems.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

### SUMMARY

This disclosure relates generally to control of steer-by-wire (SbW) steering systems.

An aspect of the disclosed embodiments includes a method for performing hysteresis shaping in a steer-by-wire (SbW) steering system of a vehicle. The method includes determining a desired hysteresis associated with rotating a handwheel of the vehicle, determining, based on the desired hysteresis, whether to perform hysteresis subtraction or perform hysteresis addition, in response to a determination to perform hysteresis subtraction, calculating a hysteresis subtraction value, modifying an estimated rack load based on the hysteresis subtraction value, and generating a reference torque based on the estimated rack load as modified based on the hysteresis subtraction value, in response to a determination to perform hysteresis addition, calculating a hysteresis addition value and generating the reference torque based on hysteresis addition value, and controlling the handwheel based on the reference torque.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a vehicle according to the principles of the present disclosure.

FIG. 1B generally illustrates a controller according to the principles of the present disclosure.

FIG. 2A generally illustrates an example rack or RWA controller and column or handwheel actuator (HWA) controller of a steering system configured to implement hysteresis shaping techniques according to the principles of the present disclosure

FIG. 2B illustrates an example reference torque calculator configured to implement hysteresis shaping techniques according to the principles of the present disclosure.

FIG. 3 is a flow diagram generally illustrating a method of performing hysteresis shaping according to the principles of the present disclosure

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

Steering systems require hysteresis in the steering effort profile in order to provide a “natural” feel to the driver. Too little hysteresis and the system feels springy, while too much hysteresis and the system feels high in friction. In connected steering systems (hydraulic power steering (HPS), electronic power steering (EPS), etc.), the overall system hysteresis is generally higher than desired due to the friction of all the components involved (both vehicle chassis components and steering system components). In SbW applications where effort is dependent on measured steering system rack force, the hysteresis is determined by the frictional component of the estimated rack force. This hysteresis could be greater or less than the desired hysteresis.

Therefore, a method to increase or decrease effort hysteresis is required for SbW and closed-loop EPS applications. Hysteresis shaping systems and methods according to the present disclosure implement techniques for applying hysteresis add or addition (increase) and hysteresis compensation or subtraction (decrease) to SbW and closed-loop EPS systems.

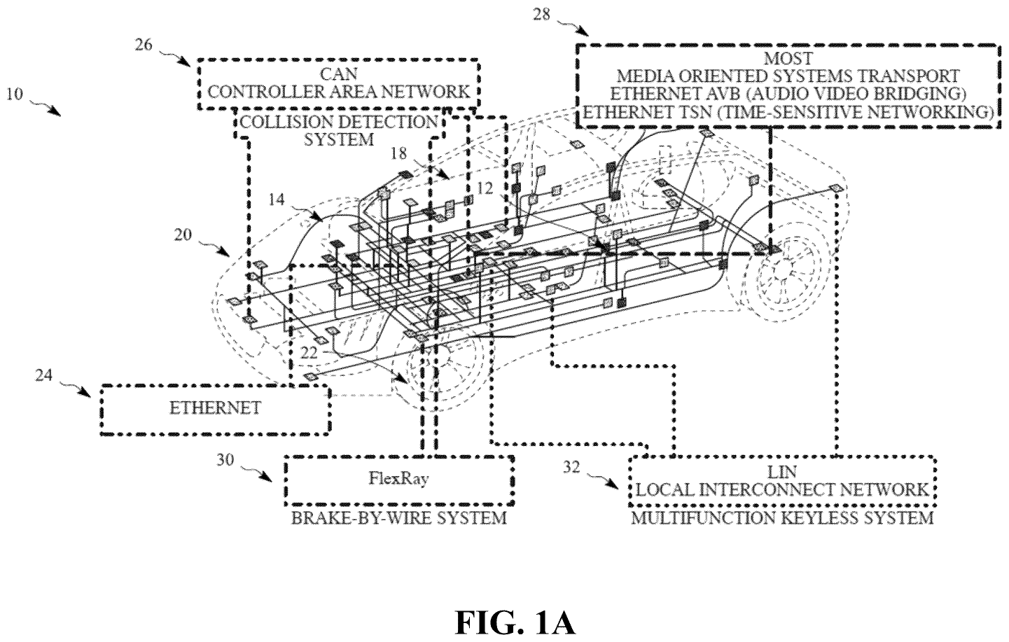

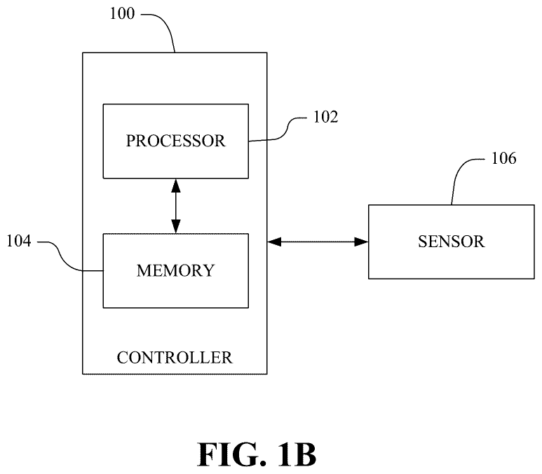

FIG. 1A generally illustrates a vehicle 10 according to the principles of the present disclosure. The vehicle 10 may include any suitable vehicle, such as a car, a truck, a sport utility vehicle, a minivan, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media-oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10. The steering system of the present disclosure is configured to implement hysteresis shaping as described below in more detail.

In some embodiments, the vehicle 10 includes one or more controllers, such as controller 100, as is generally illustrated in FIG. 1B. The controller 100 may correspond to a steering system controller. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10. Additionally, or alternatively, the memory 104 may include instructions that, when executed by the processor 102, cause the processor 102 to perform functions associated with the systems and methods described herein.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof.

As used herein, “controller” may refer to a hardware module or assembly including one or more processors or microcontrollers, memory, sensors, one or more actuators, a communication interface, etc., any portions of which may be collectively referred to as “circuitry.” As described herein, respective functions and steps performed by a given controller, control circuitry, etc. may be collectively performed by multiple controllers, processors, etc. For example, a processor, processing device, controller, control circuitry, etc. “configured to perform” may refer to a single processor, processing device, controller, etc. configured to perform both A and B or may refer to a first processor, processing device, controller, etc. configured to perform A and a second processor, processing device, controller, etc. configured to perform B. For simplicity, “control circuitry configured to perform A and B” may refer to a single or multiple processors, processing devices, controllers, etc. collectively configured to perform A and B.

In some embodiments, the controller 100 may perform the methods described herein. However, the methods described herein as performed by the controller 100 are not meant to be limiting, and any type of software executed on a controller, processor, or other circuitry can implement the hysteresis shaping techniques described herein without departing from the scope of this disclosure. For example, a controller, such as a processor executing software within a computing device, can implement the systems and methods described herein.

Hysteresis shaping systems and methods according to the present disclosure are configured to apply hysteresis add or addition (increase) and hysteresis compensation or subtraction (decrease) to SbW and closed-loop EPS systems, such as EPS systems implemented by the vehicle 10 and the controller 100 described above in FIGS. 1A and 1B.

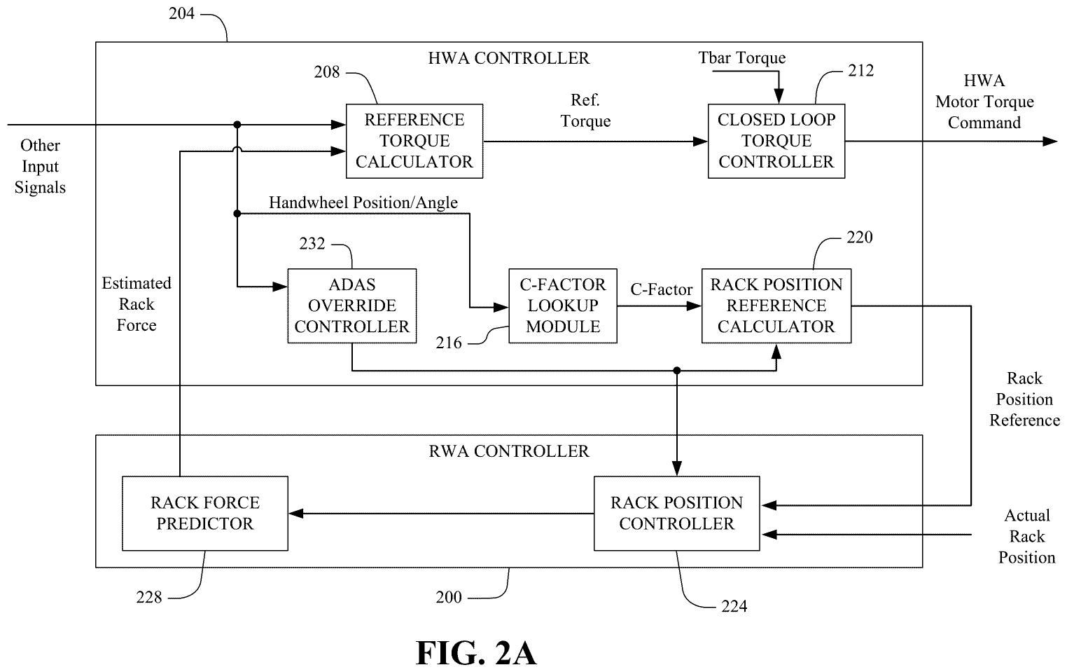

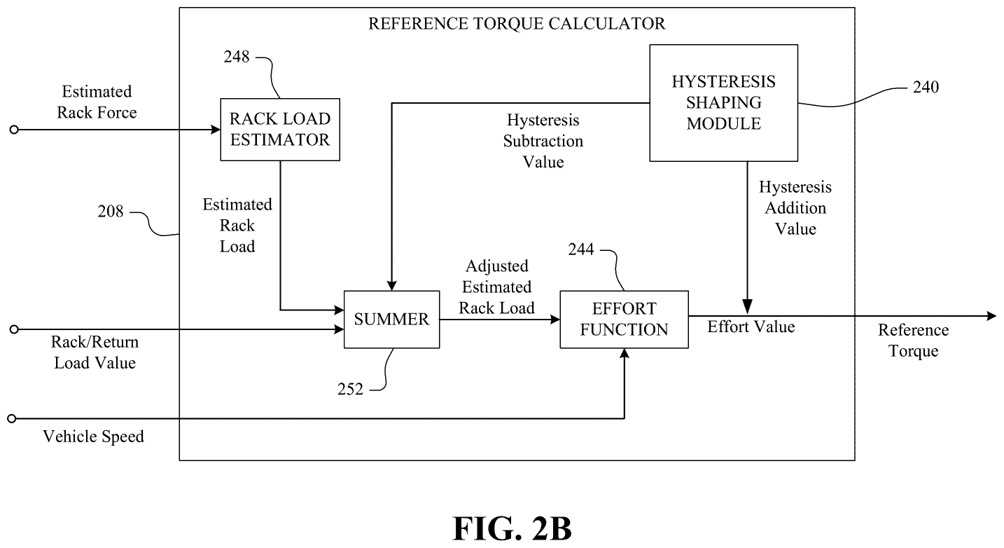

FIG. 2A illustrates an example rack or RWA controller 200 and column or handwheel actuator (HWA) controller 204 of a steering system configured to implement the hysteresis shaping techniques according to the present disclosure. For example, the HWA controller 204 is configured to generate a handwheel actuator (HWA) motor torque command based on an estimated rack force (e.g., an estimated rack force signal) received from the RWA controller 200 and one or more other input signals (e.g., vehicle speed, handwheel position, and handwheel velocity). The RWA controller 200 is configured to determine the estimated rack force based on the motor torque required to achieve or maintain an actual rack position. The controllers 200 and 204 may correspond to, be implemented by, etc. one or more steering system controllers.

As one example, the HWA controller 204 includes a reference torque calculator 208 configured to calculate a reference torque (T_{ref}) based on the estimated rack force and the one or more other input signals. For example, the reference torque corresponds to a sum of various inputs/measurements such as effort, hysteresis, return correction, damping, catch, etc. A closed loop (e.g., a PID closed loop) torque controller 212 is configured to generate and output the motor torque command based at least in part on a force or torque applied by the driver (e.g., “Tbar torque”) and the reference torque. The motor torque command is provided as a control signal to control a motor of the handwheel actuator.

The estimated rack force corresponds to the measured or estimated Roadwheel Actuator motor torque. Accordingly, the estimated rack force (and any estimated rack force offset or error) is a critical factor for determining the force provided by the motor of the handwheel actuator.

In some examples, the HWA controller 204 may further include a C-factor lookup module 216 and a rack position reference calculator 220. For example, the rack position reference calculator 220 is configured to generate the rack position reference based on a C-factor received from the C-factor lookup module 216. The C-factor may be determined based on a handwheel angle (“HwAg”) corresponding to driver input (e.g., a handwheel angle indicating driver intent conveyed via the handwheel). Example systems and methods for obtaining the rack position reference and the C-factor are described in more detail in U.S. patent application Ser. No. 18/318,657, filed on May 16, 2023, the entire contents of which are incorporated herein by reference.

The RWA controller 200 includes a rack position controller 224 (e.g., a PID rack position controller) configured to generate one or more rack position control signals based on the actual rack position and the rack position reference (e.g., based on a difference between the actual rack positon and the rack position reference). For example, the rack position control signals may include, but are not limited to, rack motor velocity and motor torque command (e.g., indicative of an amount of torque applied by the driver) signals. In this manner, rack position is controlled to follow the intent of the driver (as indicated by the rack reference position).

A rack force predictor 228 generates the estimated rack force based on outputs of the rack position controller 224 (e.g., based on a function of the rack motor velocity, the rack motor torque command, etc.). In various examples, the estimated rack force may be calculated based on the amount of torque applied to the handwheel by the driver (as indicated by the rack motor torque command, various sensor signals, etc.). As shown, the rack force predictor 228 may output the estimated rack force and the reference torque calculator 208 (and/or another component of the RWA controller 200, the HWA controller 204, etc.) may obtain an estimated rack load based on the estimated rack force. In other examples, the rack force predictor 228 may output the estimated rack load. In some contexts, the terms “estimated rack force” and “estimated rack load” may be used interchangeably.

For example, for RWA position control, the rack position reference signal (“RackPosRef”) may be calculated based on a position error (“PosErr”) between an ADAS rack position reference value or signal (“ADASRackPosRef”) and an HWA rack position reference value or signal (“HWARackPosRef”). Conversely, HWA position control is based on a position error between the HWA position and the RWA position, such that the handwheel can be controlled to rotate in a manner consistent with rotation of the roadwheel in hands-off conditions.

The reference torque may correspond to a desired, ideal, or target torque to be felt by the driver (i.e., at the handwheel/steering wheel). As described above, the reference torque is calculated based on inputs including, but not limited to, driver input (e.g., an input torque, corresponding to steering handwheel angle), road conditions, damping, hysteresis, etc. A torque at the hand wheel is controlled (e.g., via the HWA) to match the reference torque. For example, outputs of one or more sensors measuring actual torque at the wheel are used to minimize the difference between the reference torque and the actual torque.

In steering systems, hysteresis corresponds to the vertical distance between the clockwise and counterclockwise directions in a handwheel torque vs. handwheel angle (or handwheel torque vs. rack force) plot. For example, you could collect measured handwheel torque and handwheel angle data in a vehicle and use it to create a plot of handwheel torque vs. handwheel angle. The vertical separation between the clockwise and counterclockwise directions would be the amount of hysteresis felt by the driver. There is generally an ideal amount of hysteresis that provides good steering feel to the driver. Using the methods described herein, the hysteresis can be adjusted to provide this ideal profile to the driver in vehicles that use closed loop handwheel torque control steering systems.

An effort function (e.g., an effort function implemented by the reference torque calculator 208) defines a relationship between driver input (e.g., the force or torque applied by the driver to the handwheel, which may be referred to as “effort”) and a response (i.e., movement) of the steering system. For example, the effort function may output an effort value based on a lookup table or other function (e.g., by using an estimated rack load as an input). The estimated rack load may be modified prior to being input to the lookup table by adding a calculated return load value to the estimated rack load.

The effort function indicates an amount of effort required by the driver to cause a desired response. Accordingly, steering systems require hysteresis in the steering effort profile to provide a “natural” feel to the driver. In SbW systems, effort is dependent on measured or estimated steering system rack force. Accordingly, the hysteresis is determined in accordance with a frictional component of the estimated rack force. However, hysteresis determined in this manner may be greater or less than a desired hysteresis.

Systems and methods according to the present disclosure are configured to implement hysteresis shaping techniques to selectively adjust (e.g., increase or decrease) hysteresis to more accurately achieve a desired hysteresis. For example, the reference torque calculator 208 may be configured to implement hysteresis shaping as described below in more detail.

FIG. 2B shows an example implementation of the reference torque calculator 208 that includes a hysteresis shaping module 240 according to the present disclosure. As shown, an estimated rack load is input to an effort function 244. The effort function 244 may output an effort value based on a lookup table or other function (e.g., by using the estimated rack load as an input). In some examples, the estimated rack load may be modified prior to being input to the lookup table by adding a rack/return load value to the estimated rack load. For example, a rack load estimator 248 may be configured to estimate or calculate the estimated rack load, which is then adjusted prior to being input to the lookup table of the effort function 244 by adding the rack/return load value to the estimated rack load (e.g., at a summer 252). In an example, the rack load estimator 248 estimates the rack load based on one or more sensor inputs and/or calculated or modeled values (e.g., a rack force deadband value, an understeer rack force estimate, the estimated rack force, etc.). In some examples, rack load may be measured rather than estimated.

The hysteresis shaping module 240 is configured to independently perform hysteresis addition/increase and hysteresis subtraction/compensation/decrease. For example, when looking at a steering effort vs. rack load graph, adding effort hysteresis requires a shift in the effort curve along the effort axis. Accordingly, to achieve this shift along the effort axis, additional hysteresis torque is added to the reference torque being emulated by the HWA. As shown in FIG. 2B, the effort value calculated/output by the effort function 244 corresponds to a desired effort value. The hysteresis shaping module 240 calculates a hysteresis addition value (which can be a positive or negative value) to be added to the desired effort value. Accordingly, the reference torque output by the reference torque calculator 208 is modified/shifted in accordance with the hysteresis addition value. The hysteresis addition value may be calculated in accordance with one or more inputs including, but not limited to, damping, end-of-travel efforts, etc.

Conversely, when looking at a steering effort vs. rack load graph, subtracting effort hysteresis requires a shift in the effort curve along the rack load axis. Accordingly, to achieve this shift along the rack load axis, the estimated rack load input to the effort function 244 is shifted prior to being input to the effort function 244. For example, as shown, the hysteresis shaping module 240 calculates a hysteresis subtraction value, which is added to the estimated rack load. Accordingly, the adjusted estimated rack load provided to the effort function 244 is modified/shifted in accordance with the hysteresis subtraction value. The hysteresis addition value may be calculated in accordance with one or more inputs including, but not limited to, return, damping, hysteresis compensation, etc.

In this manner, the desired effort for SbW (and closed-loop EPS) systems is modified to allow for increasing and/or decreasing the desired hysteresis experienced by the driver. In one example, separate hysteresis addition and reduction methodologies are implemented as described above in FIG. 2B. This involves modifying the rack force input to the effort function to allow for hysteresis reduction and modifying the desired effort directly to allow for hysteresis addition.

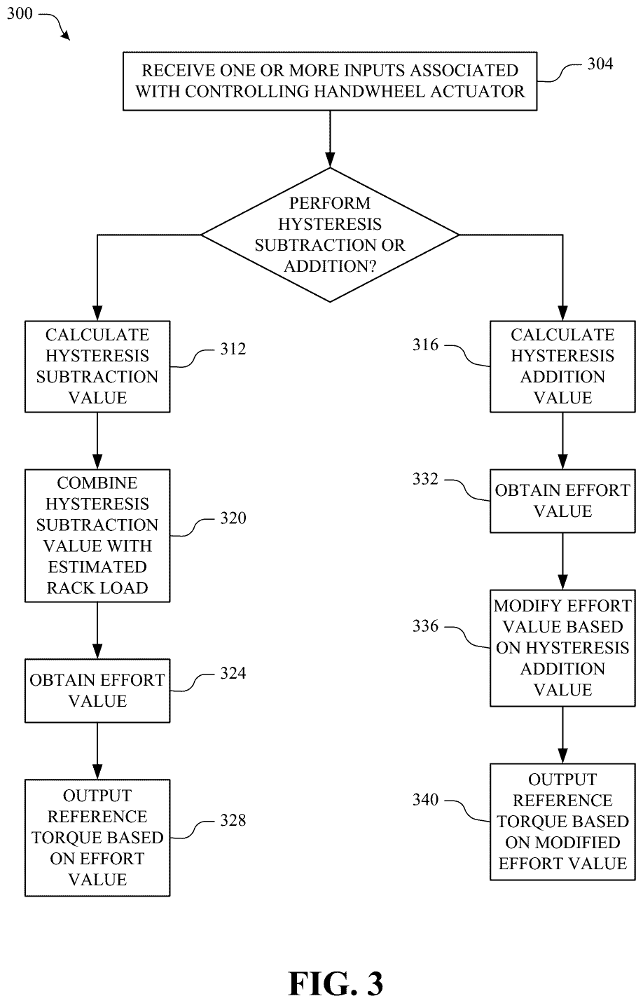

FIG. 3 is a flow diagram generally illustrating method 300 for performing hysteresis shaping according to the principles of the present disclosure. For example, one or more computing devices, processors, or processing devices, etc. are configured to execute instructions to implement the method 300, such as one or more of the processors of the systems described herein (e.g., a computing device or processor of a vehicle configured to implement the controller 100, the reference torque calculator 208, etc.). One or more of the steps of the method 300 as described below may be skipped or omitted in some examples, and/or one or more of the steps may be performed in a different sequence than described.

At 304, the method 300 includes receiving one or more inputs associated with controlling a handwheel actuator of a vehicle, such as inputs associated with calculating a reference torque. The one or more inputs may include, but are not limited to, an estimated rack force, an estimated rack load, etc.

At 308, the method 300 includes determining whether to perform hysteresis subtraction or hysteresis addition. For example, a desired hysteresis is calculated based on various inputs (e.g., measured, sensed, and/or calculated values). Based on the desired hysteresis, a determination is made to either perform hysteresis subtraction (i.e., to reduce hysteresis to achieve the desired hysteresis) or hysteresis addition (i.e., to increase hysteresis to achieve the desired hysteresis). To perform hysteresis subtraction, the method 300 continues to 312. To perform hysteresis addition, the method 300 continues to 316.

At 312, the method 300 includes calculating a hysteresis subtraction value. At 320, the method 300 includes combining the hysteresis subtraction value with the estimated rack load to obtain an adjusted estimated rack load. At 324, the method 300 includes obtaining an effort value based on the adjusted estimated rack load. At 328, the method 300 includes outputting the reference torque based on the effort value.

At 316, the method 300 includes calculating a hysteresis addition value. At 332, the method 300 includes obtaining an effort value based on an adjusted estimated rack load. At 336, the method 300 includes modifying the effort value based on the hysteresis addition value (e.g., by adding the hysteresis addition value to the effort value). At 340, the method 300 includes outputting the reference torque based on the modified effort value (i.e., the effort value as modified by the hysteresis addition value).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for performing hysteresis shaping in a steer-by-wire (SbW) steering system of a vehicle, the method comprising:
determining a desired hysteresis associated with rotating a handwheel of the vehicle;
determining, based on the desired hysteresis, whether to (i) perform hysteresis subtraction or (ii) perform hysteresis addition;
in response to a determination to perform hysteresis subtraction, (i) calculating a hysteresis subtraction value, (ii) modifying an estimated rack load based on the hysteresis subtraction value, and (iii) generating a reference torque based on the estimated rack load as modified based on the hysteresis subtraction value;
in response to a determination to perform hysteresis addition, (i) calculating a hysteresis addition value and (ii) generating the reference torque based on hysteresis addition value; and
controlling the handwheel based on the reference torque.

2. The method of claim 1, further comprising providing the estimated rack load as modified based on the hysteresis subtraction value to an effort function and generating, using the effort function, an effort value.

3. The method of claim 2, further comprising generating the reference torque based on the effort value.

4. The method of claim 1, further comprising providing the estimated rack load to an effort function and generating, using the effort function, an effort value.

5. The method of claim 4, further comprising generating the reference torque based on the effort value.

6. The method of claim 1, further comprising determining the desired hysteresis based on at least one of (i) a direction of movement of the handwheel and (ii) a determination of whether driver input to the handwheel is increasing or decreasing.

7. The method of claim 1, further comprising determining the estimated rack load based on an estimated rack force.

8. A system for performing hysteresis shaping in a steer-by-wire (SbW) steering system of a vehicle, the system comprising:
sensors configured to sense a plurality of values corresponding to operation of the SbW steering system; and
a steering system controller configured to, based on the sensed plurality of values,
determine a desired hysteresis associated with rotating a handwheel of the vehicle,
determine, based on the desired hysteresis, whether to (i) perform hysteresis subtraction or (ii) perform hysteresis addition,
in response to a determination to perform hysteresis subtraction, (i) calculate a hysteresis subtraction value, (ii) modify an estimated rack load based on the hysteresis subtraction value, and (iii) generate a reference torque based on the estimated rack load as modified based on the hysteresis subtraction value,
in response to a determination to perform hysteresis addition, (i) calculate a hysteresis addition value and (ii) generate the reference torque based on hysteresis addition value, and
control the handwheel based on the reference torque.

9. The system of claim 8, wherein the steering system controller is further configured to provide the estimated rack load as modified based on the hysteresis subtraction value to an effort function and generate, using the effort function, an effort value.

10. The system of claim 9, wherein the steering system controller is further configured to generate the reference torque based on the effort value.

11. The system of claim 8, wherein the steering system controller is further configured to provide the estimated rack load to an effort function and generate, using the effort function, an effort value.

12. The system of claim 11, wherein the steering system controller is further configured to generate the reference torque based on the effort value.

13. The system of claim 8, wherein the steering system controller is further configured to determine the desired hysteresis based on at least one of (i) a direction of movement of the handwheel and (ii) a determination of whether driver input to the handwheel is increasing or decreasing.

14. The system of claim 8, wherein the steering system controller is further configured to determine the estimated rack load based on an estimated rack force.

15. A processor configured to execute instructions stored in memory, wherein executing the instructions causes the processor to perform hysteresis shaping in a steer-by-wire (SbW) steering system of a vehicle, the instructions comprising:
determining a desired hysteresis associated with rotating a handwheel of the vehicle;
determining, based on the desired hysteresis, whether to (i) perform hysteresis subtraction or (ii) perform hysteresis addition;
in response to a determination to perform hysteresis subtraction, (i) calculating a hysteresis subtraction value, (ii) modifying an estimated rack load based on the hysteresis subtraction value, and (iii) generating a reference torque based on the estimated rack load as modified based on the hysteresis subtraction value;
in response to a determination to perform hysteresis addition, (i) calculating a hysteresis addition value and (ii) generating the reference torque based on hysteresis addition value; and
controlling the handwheel based on the reference torque.

16. The processor of claim 15, the instructions further comprising providing the estimated rack load as modified based on the hysteresis subtraction value to an effort function and generating, using the effort function, an effort value.

17. The processor of claim 16, the instructions further comprising generating the reference torque based on the effort value.

18. The processor of claim 15, the instructions further comprising providing the estimated rack load to an effort function and generating, using the effort function, an effort value.

19. The processor of claim 18, the instructions further comprising generating the reference torque based on the effort value.

20. The processor of claim 15, the instructions further comprising determining the desired hysteresis based on at least one of (i) a direction of movement of the handwheel and (ii) a determination of whether driver input to the handwheel is increasing or decreasing.
